(19) United States
(12) Patent Application Publication
(10) Pub. No.: US 2018/0125110 A1
(43) Pub. Date: May 10, 2018

(54) COMPOSITIONS SUITABLE FOR MAKING EDIBLE FILMS OR COATINGS

(71) Applicant: The United States of America, as represented by the Secretary of Agriculture, Washington, DC (US)

(72) Inventors: ZHONGLIN T. JIN, NORTH WALES, PA (US); MADHAV P. YADAV, NORTH WALES, PA (US)

(21) Appl. No.: 15/344,912

(22) Filed: Nov. 7, 2016

(51) Int. Cl. A23L 29/10; A23L 33/10

(52) U.S. Cl. CPC A23L 29/10; A23V 2002/00; A23L 33/10

(57) ABSTRACT

Disclosed are compositions suitable for making edible films or coatings, wherein the composition contains at least one biopolymer (e.g., chitosan), at least one active compound (e.g., essential oils, antioxidants, flavorings, antimicrobials), at least one bio emulsifier (e.g., bio-fiber gum), and at least one organic acid solution (e.g., acetic acid, lactic acid, levulinic acid). Disclosed are processes for making an edible film or edible coating on food, involving mixing at least one biopolymer, at least one active compound, at least one bio emulsifier, and at least one organic acid solution to form an emulsion, subjecting the emulsion to high pressure homogenization (e.g., at >15,000 psi) to form a micro-emulsion, and (1) pouring the micro-emulsion into a mold and allowing the micro-emulsion to harden into an edible film, and placing the edible film onto food, or (2) dipping the food into the micro-emulsion to form an edible coating on the food.

### BACKGROUND OF THE INVENTION

Disclosed herein are compositions suitable for making edible films or coatings, wherein the composition contains at least one biopolymer (e.g., chitosan), at least one active compound (e.g., essential oils, antioxidants, flavorings, antimicrobials), at least one bio emulsifier (e.g., bio-fiber gum), and at least one organic acid solution (e.g., acetic acid, lactic acid, levulinic acid). Also disclosed are processes for making an edible film or edible coating on food, involving mixing at least one biopolymer, at least one active compound, at least one bio emulsifier, and at least one organic acid solution to form an emulsion, subjecting the emulsion to high pressure homogenization (e.g., at >15,000 psi) to form a micro-emulsion, and (1) pouring the micro-emulsion into a mold and allowing the micro-emulsion to harden into an edible film, and placing the edible film onto food, or (2) dipping the food into the micro-emulsion to form an edible coating on the food.

Fresh foods such as produce, meat, and shell eggs are highly perishable products due to their biological composition. Many interrelated factors influence the shelf life and freshness of these foods, such as atmospheric oxygen (O₂), carbon dioxide (CO₂), temperature, endogenous enzymes, moisture, light, and most importantly microorganisms. All of these factors, either alone or in combination, can result in detrimental changes in both the quality and the safety properties of foods. For example, the oxidation of proteins and lipids in meat products is responsible for quality deterioration of meat during storage. The development of unpleasant odors and flavors makes food unsuitable for consumption. In addition, these changes not only negatively impact nutritional quality, due to the degradation of fat-soluble vitamins and essential fatty acids, but also affect the integrity and safety of food through the formation of potentially toxic compounds (Ramalho, V. C., and N. Jorge, Química Nova 29(4): 755-760 (2006)). By tracking food loss (i.e., food made inedible by moisture loss, spoilage, and other causes), the U.S. Department of Agriculture has estimated that the total value of food loss at the retail and consumer levels in the United States, as purchased at retail prices, was $165.6 billion in 2008 (Buzby, J. C., and J. Hyman, Food Policy, 37: 561-570 (2012)). A recent Centers for Disease Control and Prevention report indicated that 46% of all foodborne illnesses that led to hospitalization or death between 1998 to 2008 was attributable to fresh produce (Painter, J. A., et al., Emerg. Infect. Dis., 19(3): 407-415 (2013)). The annual burden of disease caused by 17 foodborne pathogens is over $14 billion. Pathogenic bacteria, including Salmonella enterica, Listeria monocytogenes and E. coli O157:H7, are responsible for over $6 billion. By food categories, meat (e.g., poultry, pork, beef, deli, and other meats), produce, and eggs cost $6.65 billion, $1.44 billion and $0.45 billion, respectively (Batz, M. B., et al., J. Food Protection, 75(7): 1278-1291 (2012)).

Food deterioration and pathogen contamination usually get their start on food surfaces. Therefore, food surface treatments and packaging after the treatments are critical for protecting food quality, safety, and shelf-life. Current practices do not provide effective ways to improve quality, extend shelf-life, and enhance the safety of fresh foods by just a single treatment. One of the promising ways to achieve this goal is the application of edible coatings on food surfaces. Edible coatings are composed of natural polymers having functions such as being selective gas barriers (Cerqueira, M. A., et al., J. Ag. and Food Chem., 57: 1456-1462 (2009)) and having antimicrobial action (Martins, J. T., et al., J. Ag. and Food Chem., 58: 1884-1891 (2010); Rhim, J. W., et al., J. Ag. and Food Chem., 54: 5814-5822 (2006)).

Coating of high-moisture foods puts specific constraints on the structural integrity and flexibility of the coating material. The coating should be sufficiently water-resistant to remain intact and should cover all parts of a heterogeneous product adequately when applied, for example, via dipping or spraying. Fresh fruits consist of living tissues with respiratory activity, and thus the coating should not fully deplete O₂ or lead to build-up of excessive CO₂ which may trigger physiologic deterioration, leading to anaerobic respiration and thus off-flavors, abnormal ripening, and spoilage. The minimum O₂ levels that cause anaerobic reactions vary among commodities according to the permeability of the commodity peel, respiration patterns, storage temperature, as well as the type and thickness of coatings applied. Coatings applied to such respiring products should allow for O₂ to penetrate into the package and excessive CO₂ to escape from it. As a general rule of thumb, a minimum of 1% to 3% O₂ of atmosphere in the headspace is required around a commodity to avoid a shift from aerobic to anaerobic respiration (Arvanitoyannis, I., and L. G. M. Gorris, Edible and biodegradable polymeric materials for food packaging and coating, Chapter 21, IN: Processing Foods—Quality optimization and process assessment, Edited by Oliveria, J. C., and F. A. R. Oliveria, CRC Press, 1999)).

Nanoemulsions are described as nano-sized delivery systems of nanoencapsulated lipophilic ingredients in an oil matrix, with an extremely small droplet size (Mason, T. G., et al., Nanoemulsions: formation, structure, and physical properties, J. of Physics Condensed Matter, 18(41): R635-R666 (2006); McClements, D. J., Soft Matter, 7(6): 2297-2316 (2011); Solans, C., et al., Nanoemulsions, Current Opinion in Colloid and Interface Science, 10(3-4): 102-110 (2005)). In pharmaceutical science, extensive research has been conducted on a variety of nanoemulsion-based drug delivery systems (Puri, A., et al., Critical Reviews in Therapeutic Drug Carrier Systems, 26(6): 523-580 (2009)). Microfluidization has led to good nanoemulsion or microemulsion based systems in several research studies, with droplet sizes ranging from 60 to 600 nm (Hatanaka, J., et al., Intern. J. of Pharmaceutics, 363(1-2): 112-117 (2008); Hatanaka, J., et al., Intern. J. of Pharmaceutics, 396(1-2): 188-193 (2010)). Microfluildization can be used to produce porous polymers that provide the foundation for a new generation of food coatings. Porous polymers could provide appropriate pore sizes, adequate mechanical properties, highly porous and interconnected pore structures, and high surface area to volume ratios. Porous polymers are a subset of porous materials that take advantage of the ease of processability associated with polymers to generate monoliths, films, and beads, often with well-defined porosities and high specific surface areas (SSAs) (Gokmen, M. T., and F. E. Du Prez, Progress in Polymer Science, 37:365-405 (2012); Wu, D., et al., Chemical Reviews, 112:3959-4015 (2012)). Porous polymers are of interest for such applications as microelectronics, biomedical devices, membrane processes, and catalysis, as well as for precursors that can be used to synthesize porous ceramics or porous carbons. Depending on the nature of the colloidal system employed (emulsions, microemulsions, solid particles, or breath figure droplets), the characteristic pore size can range from a few nanometers to hundreds of micrometers. Porous systems that offer the ability to manipulate the porous structure can be used for the controlled release of active compounds. Surfactants reduce the interfacial tension, reducing the droplet size, increasing the number of droplets, and reducing the walls thickness. This reduction in wall thickness allows interconnecting holes to be formed during polymerization and/or processing. Currently, there is no information available for the application of porous polymers in food surface coatings.

To make porous coating films, polymers and emulsifiers/surfactants are needed, and additional active agents are needed to make active porous coatings films. We used a biopolymer (e.g., chitosan), an emulsifier (e.g., bio-fiber gum (BFG)), and an active compound (e.g., allyl isothiocyanate (AIT), an essential oil) in combination with high pressure homogenization to develop food grade microemulsions (e.g., >about 100 nm but <about 600 nm (>100 nm but <600 nm)) that can surprisingly be used as templates for edible highly porous coatings and films.

### SUMMARY OF THE INVENTION

Disclosed herein are compositions suitable for making edible films or coatings, wherein the composition contains at least one biopolymer (e.g., chitosan), at least one active compound (e.g., essential oils, antioxidants, flavorings, antimicrobials), at least one bio emulsifier (e.g., bio-fiber gum), and at least one organic acid solution (e.g., acetic acid, lactic acid, levulinic acid). Also disclosed are processes for making an edible film or edible coating on food, involving mixing at least one biopolymer, at least one active compound, at least one bio emulsifier, and at least one organic acid solution to form an emulsion, subjecting the emulsion to high pressure homogenization (e.g., at >15,000 psi) to form a micro-emulsion, and (1) pouring the micro-emulsion into a mold and allowing the micro-emulsion to harden into an edible film, and placing the edible film onto food, or (2) dipping the food into the micro-emulsion to form an edible coating on the food.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-C show scanning electron microscopy (SEM) microphotographs of micro-emulsions as described below; FIG. 1A: 1% chitosan+5% AIT+0.5% C-BFG; FIG. 1B: 1% chitosan+5% AIT; FIG. 1C: 1% chitosan+5% AIT+0.5% C-BFG (no-HPH (high pressure homogenization)).

FIGS. 2A-C show SEM microphotographs of micro-emulsions during storage at 22° C. as described below; FIG. 2A: 0 day; FIG. 2B: 1 week; FIG. 2C: 4 weeks. Formulation: 3% chitosan+5% AIT+0.5% C-BFG.

FIGS. 3A-B show SEM microphotographs of composite films as described below; FIG. 3A: cross-section of non HPH treated film; FIG. 3B: cross-section of HPH treated film. Formulation: 3% chitosan+5% AIT+0.5% C-BFG.

FIG. 4 shows the effect of HPH treatment on antimicrobial activity of composite films against Listeria in Tryptic Soy Broth (TSB) as described below. Formulation: 3% chitosan+5% AIT+1% C-BFG. *: below minimum detection level (<1 Log CFU/ml).

FIG. 5 shows the effect of AIT concentration on reduction of Listeria innocula as described below. Formulation: 3% chitosan+0.5% C-BFG with 1% AIT(A), 2% AIT(B), 3% AIT(C), 4% AIT(D), 5% AIT(E). CK: control.

FIG. 6 shows the effect of ratio of film to TSB medium on survival of Salmonella as described below. Formulation: 3% chitosan+5% AIT+0.5% C-BFG. R1: 0.16 cm2/ml; R2: 0.08 cm2/ml; R3: 0.04 cm2/ml. CK: control. *: below minimum detection level (<1 Log CFU/ml).

FIG. 7 shows survivals of Listeria innocula on ready-to-eat (RTE) meat after film treatments and storage at 10° C. for 2 days as described below. Formulation: 1% chitosan+1% AIT+0.5% C-BFG.

FIG. 8 shows survivals of Salmonella spp. on strawberries after coating treatments and storage at 4° C. for 5 days as described below. Formulation: 1% chitosan+1% AIT+0.5% C-BFG.

FIGS. 9A-B show the appearance of strawberries stored at 4° C. for 14 days as described below; FIG. 9A: control without coating; FIG. 9B: coating treated. Formulation: 1% chitosan+1% AIT+0.5% C-BFG.

FIG. 10 shows firmness of strawberries stored at 4° C. for 21 days as described below. CK: control without coating; Coating: 1% chitosan+1% AIT+0.5% C-BFG.

FIG. 11 shows weight loss of strawberries stored at 4° C. for 21 days as described below. CK: control without coating; Coating: 1% chitosan+1% AIT+0.5% C-BFG.

### DETAILED DESCRIPTION OF THE INVENTION

Disclosed herein are compositions suitable for making edible films or coatings wherein the composition contains at least one biopolymer, at least one active compound, at least one bio emulsifier, and at least one organic acid solution. The edible films or coatings generally have pore sizes of about 100 nm to about 300 nm (e.g., 100 to 300 nm).

Organic acid solutions include solutions of acid such as acetic acid, lactic acid, and levulinic acid.

The term “active compound” refers to compounds intentionally incorporated into polymers and release to or interact with food and play special functions, such as antimicrobial, antioxidation, color, taste or flavor enhancement, etc. That is, “active compound” has an active function, compared to a polymer that is just a base material, not active with food. Examples of active compound are antimicrobials (e.g., essential oils), antioxidants (e.g., essential oils), flavorings, etc. Thus active compounds are components of a product which (irrespective of their relative quantity) help directly in achieving its performance objectives, for example antimicrobials, antioxidants, flavorings, etc.

The term “biopolymer” means a polymer produced by a living organism. Typical examples include proteins, and carbohydrates such as cellulose and cellulose derivatives. The biopolymer is preferably a polysaccharide such as chitosan.

The term “emulsifiers” (surfactants) include BFG and any gums from bio sources (e.g., gum arabic, guar gum, etc.). Emulsifiers which are generally not used are, for example, derived from polyethoxylated sorbitan and oleic acid which includes Tween® 80.

The compositions (which can be edible films or edible coatings) generally are produced by processes involving mixing at least one biopolymer, and at least one active compound, at least one bio emulsifier, at least one organic acid solution at ambient temperature for about 10 to about 14 hours (e.g., 10 to 14 hours; preferably about 12 hours (e.g., 12 hours)) to form an emulsion, and subjecting the emulsion to high pressure homogenization (e.g., >about 15,000 psi (>15,000 psi), a person skilled in the art would understand that the upper limit will depend upon the equipment used) at about 18,000 to about 22,000 psi (18,000 to 22,000 psi) for about 2 to 4 cycles, preferably at about 20,000 psi (138 MPa; 20,000 psi) pressure for about 3 cycles to form a micro-emulsion which can be (1) poured into a mold and allowed to harden into an edible film, and placing the film onto food, or (2) food can be dipped (immersed, sprayed, etc.) into the micro-emulsion and dried to form an edible coating on food. The micro-emulsion is composed of spherical particles with sizes ranging from about 100 to about 300 nm (e.g., 100 to 300 nm). The edible films or edible coatings have micro-channels (e.g., gap or diameter of the channels is less than about 600 nm (less than 600 nm), the lower limit is generally 50 nm although it is possible to obtain smaller diameters).

The term “food” includes fruits, vegetables, meat products (e.g., beef, pork, poultry, fish, seafood), and prepared products. Particularly included are apples, melons, apricots, peaches, pears, avocados, bananas, artichokes, beans, bell peppers, carrots, celery, corn, garlic, horseradish, leeks, lima beans, mushrooms, onions, parsnips, peas, pimiento, tomato, turnips, lettuce, tomatoes, corn, garlic, horseradish, leeks, lima beans, mushrooms, onions, parsnips, peas, pimiento, tomato, turnips, lettuce, and tomatoes. Foods also include tubers (e.g., Solanum tuberosum including varieties Russet potatoes, Kennebec potatoes, Hilite potatoes, Norkata potatoes, and Norgold potatoes). Foods particularly include fresh-cut produce (e.g., fruits and vegetables) which is produce that has been, for example, peeled, cut, sliced, or shredded. The fruits and vegetables may be subjected to various processing techniques wherein they are subjected to disorganization of their natural structure, as by peeling, cutting, comminuting, pitting, pulping, freezing and dehydrating. Meat products include, for example, ready-to-eat (RTE) meats and poultry products which include a vast array of products such as bacon, ham (whole or partial), fresh or fermented sausages of all types (such as beef, pork, chicken, turkey, fish, etc.), deli and luncheon meats, hotdogs (frankfurters), bologna and kielbasa type products, delicatessen specialties and pâtés, dried meat and poultry products, such as beef jerky and turkey jerky; and frozen meat and poultry such as pre-cooked frozen beef patties and pre-cooked frozen fried chicken. The term “ready-to-eat meat product” means a meat product that has been processed so that the meat product may be safely consumed without further preparation by the consumer, that is, without cooking or application of some other lethality treatment to destroy pathogens. Thus, unlike other meat products, ready-to-eat meat products are generally consumed without further cooking; therefore, they require that pathogens be rigorously controlled during processing and storage. Meat products also include uncooked meat products.

Other compounds may be added to the composition provided they do not substantially interfere with the intended activity and efficacy of the composition; whether or not a compound interferes with activity and/or efficacy can be determined, for example, by the procedures utilized below.

The amounts and ranges disclosed herein are not meant to be limiting, and increments between the recited percentages and ranges are specifically envisioned as part of the invention.

“Optional” or “optionally” means that the subsequently described event or circumstance may or may not occur, and that the description includes instances in which said event or circumstance occurs and instances where it does not. For example, the phrase “optionally comprising a defoaming agent” means that the composition may or may not contain a defoaming agent and that this description includes compositions that contain and do not contain a foaming agent.

By the term “effective amount” of a compound or property as provided herein is meant such amount as is capable of performing the function of the compound or property for which an effective amount is expressed. As will be pointed out below, the exact amount required will vary from process to process, depending on recognized variables such as the compounds employed and the processing conditions observed. Thus, it is not possible to specify an exact “effective amount.” However, an appropriate effective amount may be determined by one of ordinary skill in the art using only routine experimentation.

Unless defined otherwise, all technical and scientific terms used herein have the same meaning as commonly understood by one of ordinary skill in the art to which the invention belongs. As used herein, the term “about” refers to a quantity, level, value or amount that varies by as much as 10% to a reference quantity, level, value or amount. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### Examples

Materials: Chitosan (low molecular weight, 150 kDa, 75-85% deacetylation), allyl isothiocyanate (AIT, 95% purity), and emulsifier Tween® 80 were purchased from Sigma Aldrich (St. Louis, Mo.). Food grade acetic, lactic, and levulinic acids were purchased from Fisher Scientific (Fairlawn, N.J.).

Isolation of Corn Bio-Fiber Gum (C-BFG; U.S. Pat. No. 9,434,788): corn fiber was oven dried and ground to a 20-mesh particle size using a Wiley mill. The ground corn fiber was extracted with hexane to remove oil (Moreau, R. A., et al., J. of Ag. and Food Chem., 44: 2149-2154 (1996)) and treated with thermostable α-amylase (a gift from Novo Nordisk Bioindustrials, Inc., Danbury, Conn.) at 90°−95° C. to hydrolyze the starch present in corn fiber (Yadav, M. P., et al., Food Hydrocolloids, 21, 1022-1030 (2007)). Corn bio-fiber gum (C-BFG) was isolated from the de-oiled and de-starched corn fiber following the alkaline extraction technology of Yadav et al. (2007) with some modification. De-oiled and de-starched corn fiber (50 g) was stirred using a mechanical overhead propeller stirrer with blade (IKA RW 20) into water (1.0 liter) and NaOH (12 g or 24 ml from 50% solution) was carefully added in an open beaker in a fume hood. The mixture was boiled with sufficient mechanical stirring for 1 h. During the reaction, its pH was kept at 11.5 by adding 50% NaOH as needed. After cooling the hot reaction mixture by stirring at room temperature for an additional half an hour, it was centrifuged at 6000×g for 20 min and the supernatant was separated from the residue by decantation. The pH of the alkaline extract was then adjusted to 4.0-4.5 by adding concentrated HCl to precipitate Hemicellulose A (acid-insoluble arabinoxylan, “Hemi. A”), which was collected by centrifugation at 10,000 g for 30 min. Two volumes of ethanol (2.0 liters) were gradually added to the supernatant (1.0 liter) with stirring to precipitate the major arabinoxylan fraction, Hemicellulose B, or “Hemi. B” (C-BFG). The C-BFG was allowed to settle out as a white flocculent precipitate at the bottom of the beaker for 10-15 min. The clear alcohol/water mixture above the precipitate was removed by decantation. The white flocculent precipitate was transferred into another beaker, stirred in 100% ethanol and filtered under vacuum. The white residue obtained on the Buchner funnel was washed with 100% ethanol and dried in a vacuum oven at 50° C. overnight.

Preparation of micro-emulsions and casting of composite films: Chitosan (1-3% w/v), AIT (1-5% v/v), and C-BFG or Tween® 80 (0.5% w/v) were dispersed in an acid solution containing 2% (v/v) acetic acid (AA), lactic acid (LA), or levulinic acid (LevA), or their combinations, under constant agitation using stir plates at ambient temperature for 12 h to make coarse emulsions. The coarse emulsions were passed through an EmulsiFlex-B3 high-pressure homogenizer (Avestin Inc., Ottawa, Canada) at 138 MPa (20,000 psi) pressure for 3 cycles to prepare micro-emulsions.

Ten milliliters of coarse emulsions and micro-emulsions (film forming solutions) were separately casted in 57 mm diameter aluminum petri plates and vacuum dried at 35° C. for 24 h. The films were peeled off from the aluminum petri plates before use. The average film thickness was 0.22 mm.

Inoculum preparation: Three Listeria innocua strains (ATCC 33090, 33091, 51742) from the American Type Culture Collection (Manassas, Va.) and four serovars of Salmonella enterica (Salmonella Newport H 1275, St. Paul 02-517-1, Stanley H0558, and Montevideo G4639) were used in this study. Frozen stock cultures of each strain were cultured independently in 30 ml Tryptic Soy Broth (TSB) (BBL/Difco Laboratories, Sparks, Md.) in sterile 50 ml conical tubes at 37° C. for 18 h. Equal volume aliquots from each culture were then combined to make a multi-strain cocktail. Different initial cell populations in the TSB test tubes were achieved by adjusting the dilution levels of the innocula.

Determination of morphology of emulsions and films: Scanning electron microscopy (SEM) was used to determine morphology of films and emulsion solutions. Emulsion solution samples were diluted 100 times and coated on stubs and sputter gold coated 70s×2 (Edwards Scancoat 6, West Sussex, UK). They were then observed with Scanning Electron Microscope, FEI Quanta 200 F (Hillsboro, Oreg.) with an accelerating voltage of 10 KV in high vacuum mode.

Film samples were dry-fractured with scalpel blades into 3×5 mm² pieces, and cross-sectioned fragments were mounted vertically on specimen stubs using glue (Duco Cement, ITW Performance Polymers, Riviera, Fla.). Prior to viewing, the samples were sputter coated with a thin layer of gold using a model Scancoat SixSputter Coater (BOC Edwards, Wilmington, Mass.).

Digital images of film and emulsion solution samples were collected using a Quanta 200FEG environmental scanning electron microscope (FEI Co., Inc., Hillsboro, Oreg.) operated in a high vacuum/secondary electron imaging mode at an accelerating voltage of 10 kV and instrumental magnifications of 25,000 times.

Antimicrobial activity of composite film in TSB: Casted films were cut into 0.4×1 cm squares. One, two, or four pieces of film samples were placed into test tubes containing 10 ml of TSB inoculated with L. innocua culture prepared above. The TSB tubes were then incubated at 22° C. for 0, 24, and 48 h with constant shaking at 100 rpm. To determine the bacterial populations in TSB after incubation, serial dilutions of the resultant bacterial suspensions were made in 0.1% peptone water and surface-plated (100 μl) onto PALCAM agar plates (BBL/Difco) with PALCAM selective supplement (Oxoid, England) for Listeria and Tryptic Soy Agar with 0.1% sodium pyruvate and 100 ppm nalidixic acid (TSAPN) for Salmonella. All plates were then incubated at 37° C. for 48 h. The bacterial cell density was then counted and expressed in units of log₁₀ CFU/ml.

Antimicrobial activity of composite film on RTE meat. Meat sample preparation: Pre-sliced turkey deli meat (containing no preservatives) was purchased from a local grocery store; the thickness was approximately 1 cm. Meat slices were cut into 4×4 cm squares, vacuum-packaged, and stored in a freezer at −20° C. Prior to each experiment, the meat samples were thawed overnight at 4° C.

Film treatment for meat sample: Meat samples were placed on a sterile tray in a biological hood, and the upper surface (3×3 cm) of each sample was inoculated with 0.1 ml of L. innocua cocktails. The inoculum was then spread evenly over the surface (3×3 cm) using sterile spreaders (Fisher Scientific, Fair Lawn, N.J.). After inoculation, samples were kept under a biohood for 2 h to allow bacterial attachment.

One piece of film (approximately 4×4 cm) was put on the top of each inoculated RTE turkey slice, and the samples were packed into a vacuum pouch (152.4×203.2×0.08 mm, polynylon; Uline, Inc., Waukegan, Ill.), and hermetically sealed in a vacuum sealer (Model V-300, Fuji Impulse Co., Japan). Inoculated samples without films were vacuum-packed and served as the controls. All meat samples were stored at 10° C. to simulate mild temperature abuse.

Antimicrobial activity of composite film on strawberries. Strawberry sample preparation: Strawberries were purchased at local supermarkets and stored at 4° C. until the time of the experiments. Strawberries were partially immersed into the six strain inoculum and then flooded with 50 mL of the inoculum three times. Inoculated strawberries were then placed on a sterile pan in a laminar flow hood and dried under continuously circulating laminar flow for two hours at room temperature (approximately 22° C.).

Coating treatment for strawberries: Strawberries were dipped in the coating solution for 1 min. The coated and non-coated (control) samples were dried under a bio-hood for 2 h at room temperature (22° C.) and then were stored on PET boxes, all boxes were kept at 4° C.

Weight loss of strawberries: To determine weight loss, the same strawberries were weighed at the beginning of the experiment after the setting of the coating and thereafter each day during the storage period. Weight loss was expressed as the percentage loss of the initial total weight. Five fruits in three repetitions were used to evaluate the weight loss of every group.

Firmness measurement: The compression force of strawberries was measured with a TA-XT2i Texture Analyzer (Texture Technologies Corp., Scarsdale, N.Y.). The fruits were cut longitudinally in two parts and compressed by a cylindrical probe (6 mm of diameter) with a crosshead speed of 2 mm/s to penetrate fruit to a depth of 10 mm. Three fruits from each of 2 replicated containers were used for firmness measurements, and there were a total of 12 measurements. Maximum force was recorded using the Texture Expert software (version 1.22, Texture Technologies Corp.). The fruits were analyzed at the beginning of the experiment and every 7 days during the storage of the samples.

Microbiological analysis: On each sampling day, untreated and treated food samples were transferred into individual sterile stomacher bags and then hand-massaged in 20 ml of 0.1% peptone water for one min. Sterile dilutions of the resultant bacterial suspensions were made in 0.1% peptone water and surface-plated (100 μl) onto PALCAM plates for Listeria or Tryptic Soy Agar with 0.1% sodium pyruvate and 100 ppm nalidixic acid (TSAPN) for Salmonella, and then incubated at 37° C. for 48 h. The colony forming units (CFU) were then enumerated. Bacterial cell density was expressed in units of log₁₀ CFU/cm².

Statistical analysis: All experiments were conducted in triplicate. The CFU per milliliter or CFU per square centimeter numbers were transformed to log₁₀ values and analyzed using Analysis of Variance with SAS version 9.1 software (SAS Institute, Carry, N.C.). Ducan's Multiple Range Test was used to determine the significant differences between treatment means. A significance value was defined as p<0.05.

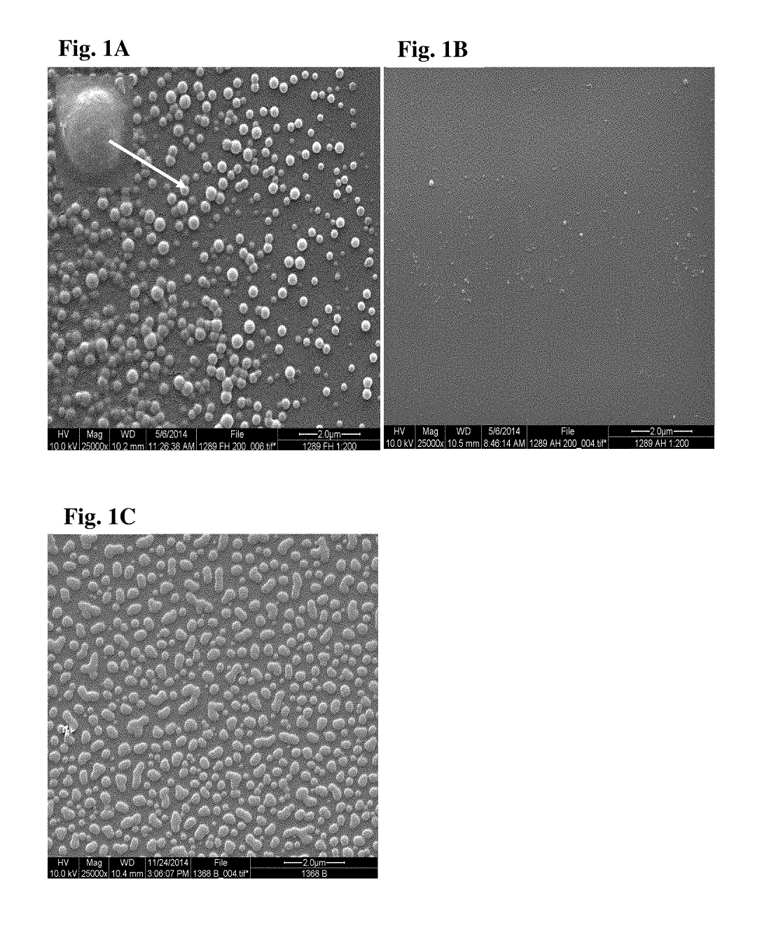

Results: As shown in FIG. 1A, after high pressure homogenization (HPH) processing, the emulsion with C-BFG surprisingly formed clear and spherical emulsion drops. In contrast, the emulsion without C-BFG did not form drops or just formed a few drops (FIG. 1B), which confirmed that the presence of an emulsifier (C-BFG) surprisingly played an important role in the micro-emulsion. The inserted SME image in FIG. 1A shows the outmost layers surrounding the spherical drops, suggesting a combination of C-BFG with chitosan could surprisingly provide an inter-biopolymer electrostatic complex that would form strong viscoelastic films around AIT.

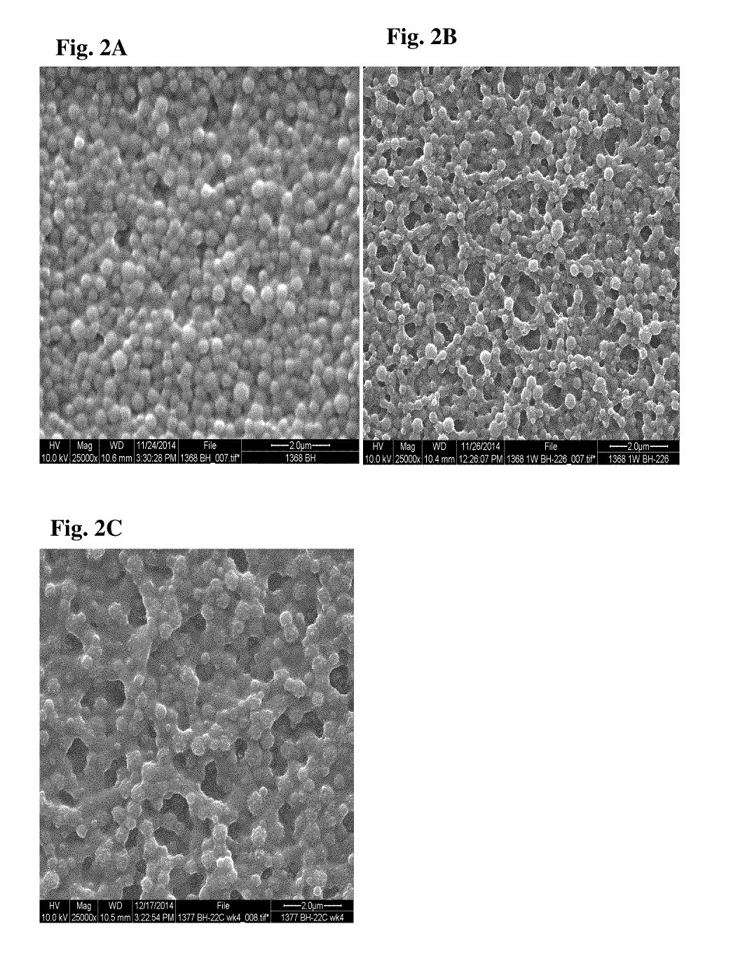

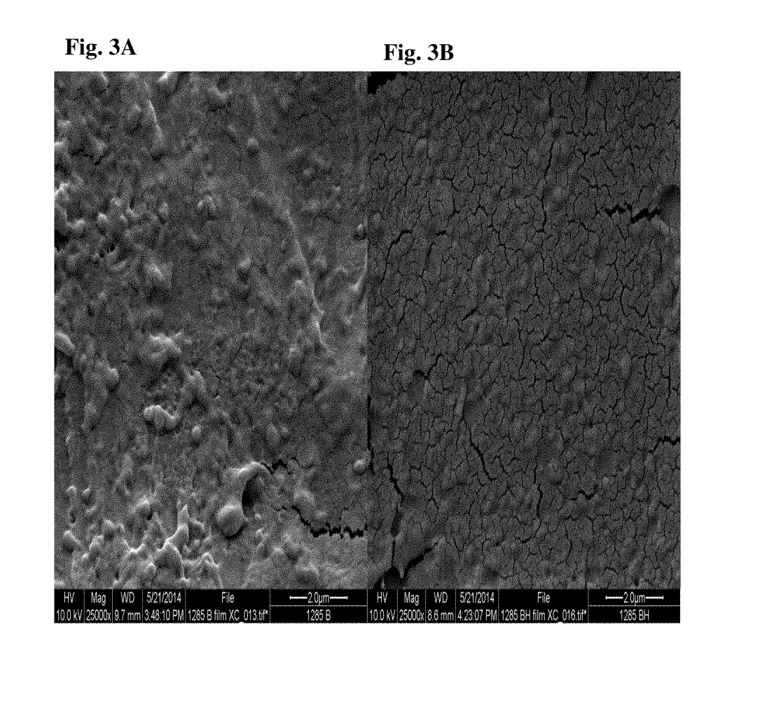

In this study, with the aid of C-BFG, HPH processing at 138 MPa for three cycles surprisingly produced micro-emulsions with droplet sizes ranging from 100 to 300 nm (FIG. 1A). In contrast, the same formula without HPH processing could not form similar micro-emulsions (FIG. 1C), which also confirmed that the HPH process was surprisingly necessary for producing a micro-emulsion or nano-emulsion. During storage, these droplets in HPH treated emulsions (FIG. 2A) surprisingly grew spontaneously to an equilibrium diameter after 1 week (FIG. 2B), further leading to a large number of uniformly dispersed spherical particles and more homogenous microstructure (FIG. 2C). SEM images show that many micro-channels in the cross-section of the composite films after the drying process were also surprisingly formed around the micro-particles (FIG. 3B), while the non-HPH treated film did not have such channels (FIG. 3A), indicating that the HPH processing is surprisingly necessary to form the micro-channels across the film. The coating films surprisingly formed micro channels and pores (FIGS. 2B&C and FIG. 3B)) that would facilitate the release of antimicrobials/antioxidants, modification of barrier properties to CO₂, O₂, moisture, and UV light. The numbers of pores and the size of micro channels and pores can be manipulated by coat formulations and HPH treatment conditions to meet different needs.

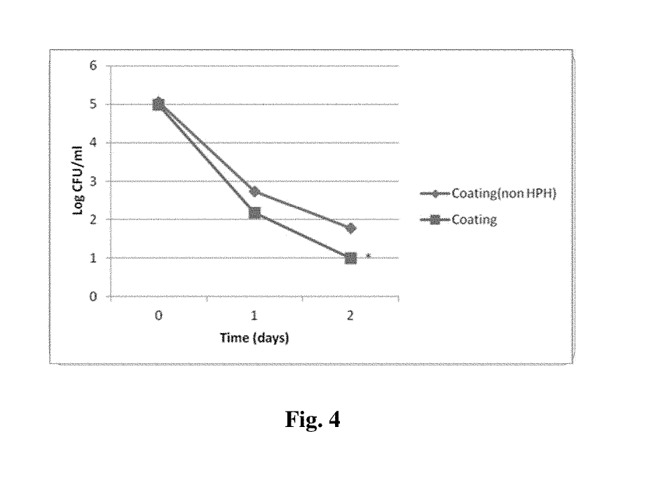

Surprisingly, HPH treatments significantly enhanced the antimicrobial effectiveness of the composite films as shown in FIG. 4 as compared to emulsions without HPH treatments. The smaller the particle the greater is the exposed surface area, which leads to more availability of active compound (AIT) on the film surface. In addition, the reduction of the particle size surprisingly gives rise to a more homogeneously distributed encapsulated AIT in the micro-emulsions and then micro-particles with micro-channels cross the film, which allows for the migration of the antimicrobial to the film surface and then release into liquid media (TSB) or foods, providing a continuous antimicrobial effect on the food during extended exposure.

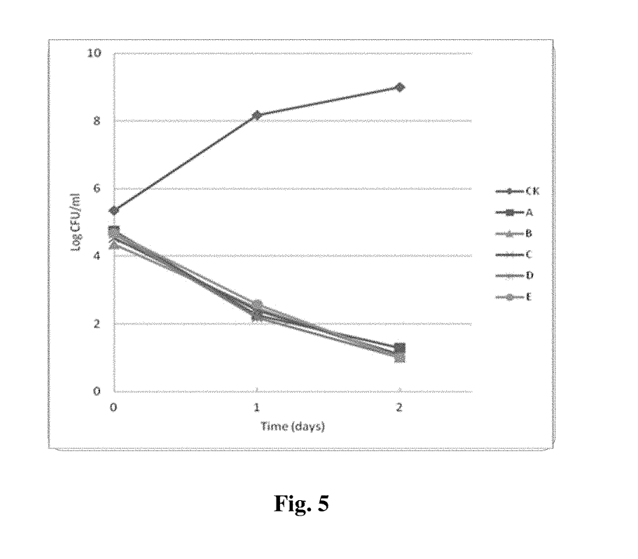

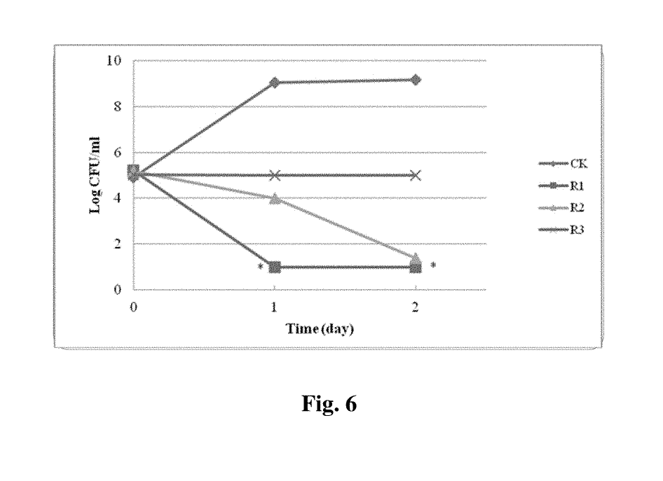

As shown in FIG. 5, there was no significant difference (p>0.05) in reduction of Listeria in TSB between 1% to 5% AIT in the coating solutions. Without being bound by theory, this implies that the film formulation (3% chitosan and 0.5% C-BFG) could only hold or encapsulate 1% AIT in the microstructure, and extra AIT would be lost during the film forming (drying). Increasing the concentrations of chitosan and C-BFG may increase the AIT holding capacity. As shown in FIG. 6, decrease of film size in TSB resulted in decrease of the microbial reduction. Therefore, AIT encapsulated in the film matrix, and not AIT in the formulation, played a key role in antimicrobial activity. The combination of chitosan and C-BFG with HPH treatment surprisingly generated such micro pores and channels that can effectively hold AIT in the film or coating matrix. We also predict that the film matrix can effectively hold other active compounds such as antioxidants, flavorings, etc.

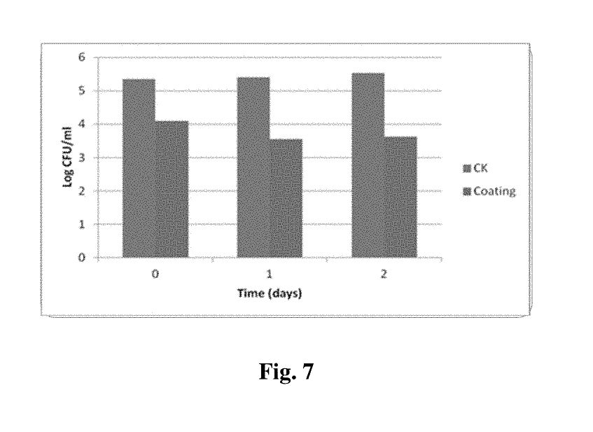

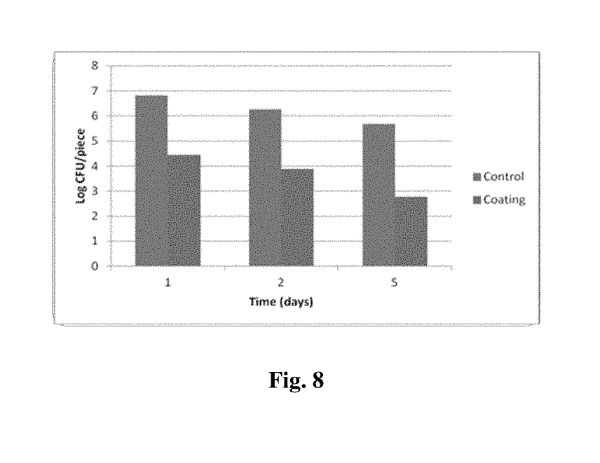

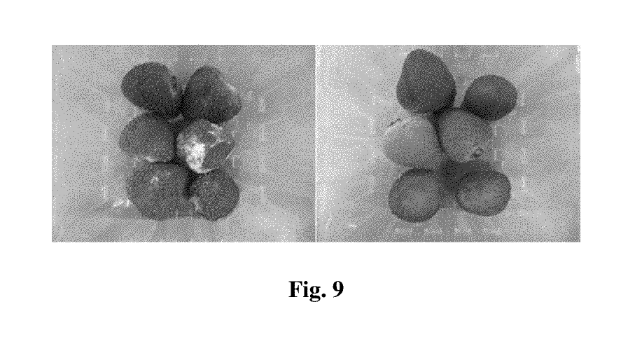

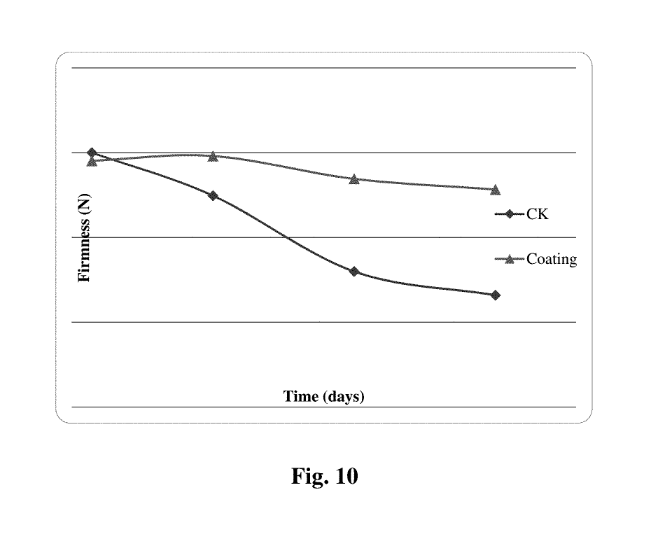

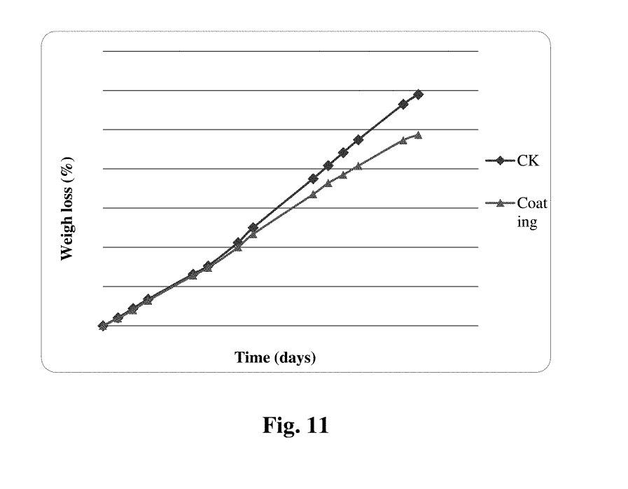

When composite coating and films were applied on real food, they significantly reduced microbial loads. The survival of Listeria on RTE meat after film treatments was surprisingly reduced by approximately 2 logs compared to controls (FIG. 7). The survival of Salmonella on fresh strawberries after coating treatments were surprisingly reduced by approximately 3 logs after 5 days of storage compared to controls (FIG. 8). In addition, the coat-treated strawberries surprisingly showed better fresh-like appearance and no mold growth after 14 days of storage at 4° C. (FIG. 9). Surprisingly, the coating treatments also significantly maintained the texture quality (firmness) of fresh strawberries (FIG. 10) and caused less weight loss (FIG. 11) than controls after 21 days of storage at 4° C., which suggested that the coating on the strawberry surface surprisingly created a suitable CO₂/O₂ exchange rate and a moisture barrier for fresh strawberries in addition to the antimicrobial activity.

Discussion: Chitosan has a great potential for a wide range of food applications due to its biodegradability, biocompatibility, antimicrobial activity, non-toxicity, and film forming capacity, and has been used for edible films or coatings (Butler, B. L., et al., J. of Food Sci., 61 (5): 953-955 (1996); Guo, M., et al., J. of Food Sci., 78: M1195-M1200 (2013a); Guo, M., et al., J. of Food Control, 40: 64-70 (2013b); Guo, M., et al., Food Control, 34: 24-30 (2013c); Jeon, Y. J., et al., J. Agric. Food Chem., 50: 5167-78 (2006)). Chitosan based films have been proven to have moderate oxygen barrier properties and good carbon dioxide barrier properties but high water vapor permeability due to their hydrophilic nature (Butler et al. 1996). Combined antimicrobial effects have been described for chitosan films containing essential oils (Sanchez-Gonzalez, L., et al., Carbohydrate Polymers, 82: 277-283 (2010)) while their water barrier properties were also improved when these hydrophobic compounds were incorporated in composite films.

Tween® 80 and lecithin are two common emulsifiers used for food emulsion. However, due to their sensitivities to light and oxygen and the results of oxidation, they are not suitable for surface coatings. Different emulsifiers are needed, particularly for the surface coating to prevent oxidation. Corn fiber gum (CFG) is an arabinoxylan (a hemicelluloses B) that can be extracted from corn fiber, a low-value byproduct of corn wet- and dry-milling processes that consists of the pericarp and endosperm fiber of the corn kernel. It is produced in large quantities during the corn wet-milling process, which fractionates corn kernels into starch, oil, fiber, and protein streams (Yadav, M. P., et al., Food Hydrocolloids, 23: 1488-1493 (2009)). We have found that its emulsion-stabilizing capacity, low cost, and lower sensitivity to light and oxygen make it surprisingly superior compared to Tween® 80 and lecithin for food coatings.

Essential oils (EOs) have been used in edible coatings for various foods due to their effective antimicrobial and antioxidant properties and their status as natural products. In our previous studies, AIT in coatings showed strong antimicrobial activity against spoilage microorganisms and human pathogens in fruits, meats, shrimp, and eggs (Chen, W., et al., Intern. J. of Food Microbiology, 155: 165-170 (2012); Guo et al. 2013a, 2013b, 2013c; Jin, T. and J. Gurtler, J. of Applied Microbiology, 110: 704-712 (2011); Jin, T., and J. Gurtler, J. of Food Protection, 75(8): 1368-1372 (2012)). However, EOs are volatile compounds that easily evaporate and/or decompose during food processing, formulation, and preparation of antimicrobial/antioxidant films, etc., due to direct exposure to heat, pressure, light, or oxygen. In order to overcome these problems and improve the stability of bioactive compounds during processing and storage, the emerging technology of nano-encapsulation has been recently applied in food and nutraceutical industries. Nano-encapsulation of bioactive compounds represents a viable and efficient approach to increase the physical stability of the active substances, protect them from the interactions with the food ingredients, and enhance their bioactivity, because of the subcellular size (Donsì, F., et al., LWT: Food Science and Technology, 44: 1908-1914 (Donsì et al. 2011)). In other words, encapsulation can reduce the loss in activity of the active compounds. In the case of antimicrobials, the nano-level encapsulation can increase the concentration of the bioactive compounds in food areas where microorganisms are preferably located (Weiss, J., et al., Nanostructured encapsulation systems: Food antimicrobials, IN: G. V. Barbosa-Cánovas, A. Mortimer, D. Lineback, W. Spiess, & K. Buckle (Eds.), IUFoST World Congress Book: Global issues in food science and technology (pp. 425-479), 2009, Amsterdam, Elsevier, Inc.). Nevertheless, prior to the present study, there is a lack of information about the effect of processing conditions to produce microfluidized essential oil loaded nanoemulsions as food coatings.

Although the ingredients (chitosan and corn bio-fiber gum) in the coating formulation and method (HPH) used in this study have been separately reported in the literature, we used a different approach to make advanced packaging materials from micro-emulsions through HPH processing with the aid of plant emulsifiers that can be used as edible antimicrobial composite films and coatings: 1) Chitosan/AIT coatings or films have been used for antimicrobial/antioxidant or moisture barrier purposes, but no report has demonstrated multiple functions of coatings and films through micro-pores and channels surprisingly found in this study. 2) Plant compounds, such as corn bio-fiber gum, have been used as emulsifiers for juices and beverages, but no report has shown they can be used for edible coatings and films before this study; we used a plant emulsifier, corn bio-fiber gum, to surprisingly stabilize the emulsion during and after high pressure homogenization. Corn bio-fiber gum is low cost and less sensitive to light and oxygen than artificial emulsifiers, which makes it unique for this application. 3) High pressure homogenization (HPH) has been used with other chemicals to make porous polymers for such applications as microelectronics and biomedical devices, but currently there is no information available for the application of porous polymers made from natural and edible materials and used for food surface coating or packaging. The combination of HPH and plant emulsifier is another innovative approach.

As demonstrated in the present study, our micro-emulsion films surprisingly had better antimicrobial efficacy than non-HPH treated films due to smaller emulsion sizes and micro-particles. These developed coatings and films have multiple functions: barriers to CO₂, O₂, moisture, controlled release of active compounds, blockage of UV light, etc., that surprisingly lead to improved quality and extended shelf-life of foods. In addition, the coatings with antimicrobials also surprisingly reduced or inhibited the growth of pathogens and prevent recontamination after packaging. Implementation of this approach by food industry, leading to even a 1% rate of reduction in spoilage and foodborne illnesses, could save over $1 billion of food losses and reduce disease related costs by as much as $60 million annually. Furthermore, the edible coatings can enable fortification of food products with desirable quality characteristics such as improved nutrition (added vitamins and minerals), color, flavor, spiciness, acidity, sweetness, and/or saltiness.

Conclusions: Advanced packaging materials can surprisingly be made from micro-emulsions through HPH processing with the aid of plant emulsifiers and used as edible antimicrobial composite films and coatings. The films and coatings have micro-pores and channels that facilitate the release of active compounds (e.g., antimicrobials, antioxidants) from the center to the surface of the films or coatings, hence, surprisingly enhancing its antimicrobial/antioxidant efficacy in foods. Surprisingly the developed composite films from HPH treated micro-emulsions significantly reduced L. innocua in TSB and RTE-meat and Salmonella spp. in TSB and strawberries. In addition, by adjusting homogenization pressure and solution formulation, the size and number of micro-pores and channels in the films can be manipulated, which regulate the exchanges of moisture, O₂, and CO₂ between food and its environment, therefore keeping food fresher. The present study demonstrated the surprising success in producing edible micro-emulsion films from natural and renewable sources, particularly C-BFG, which can be obtained from grain processing by-product or agricultural wastes and add commercial value to these residues. This study provides an innovative approach to develop advanced packaging materials that can surprisingly be used to improve the quality, shelf-life and safety of fresh produce, meats, and other foods.

All of the references cited herein, including U.S. patents and U.S. patent application Publications, are incorporated by reference in their entirety. Also incorporated by reference in their entirety are the following references: Guo, M., et al., Intern. J. of Food Microbiology, 208: 58-64 (2015); Guo, M., et al., Intern. J. of Food Microbiology, 208: 58-64 (2015); Nadarajah, K., et al, J. Food Sci., 71(2):E33-9 (2006); U.S. patent application Ser. No. 13/768,036 filed on 15 Feb. 2013 (0002.12).

Thus, in view of the above, there is described (in part) the following:

A composition suitable for making edible films or coatings, said composition comprising (or consisting essentially of or consisting of) at least one biopolymer, at least one active compound, at least one bio emulsifier, and at least one organic acid solution. The above composition, wherein said at least one biopolymer is chitosan. The above composition, wherein said at least one active compound is selected from the group consisting of essential oils, antioxidants, flavorings, antimicrobials, and mixtures thereof. The above composition, wherein said bio emulsifier is bio-fiber gum. The above composition, wherein said at least one organic acid solution is selected from the group consisting of acetic acid, lactic acid, levulinic acid, and mixtures thereof.

A process for making an edible film or edible coating on food, said method comprising (or consisting essentially of or consisting of) mixing at least one biopolymer, at least one active compound, at least one bio emulsifier, and at least one organic acid solution to form an emulsion, subjecting said emulsion to high pressure homogenization to form a micro-emulsion, and (1) pouring said micro-emulsion into a mold and allowing said micro-emulsion to harden into an edible film, and placing said edible film onto said food, or (2) dipping said food into said micro-emulsion to form an edible coating on said food. The above process, wherein said at least one biopolymer is chitosan. The above process, wherein said at least one active compound is selected from the group consisting of essential oils, antioxidants, flavorings, antimicrobials, and mixtures thereof. The above process, wherein said bio emulsifier is bio-fiber gum. The above process, wherein said at least one organic acid solution is selected from the group consisting of acetic acid, lactic acid, levulinic acid, and mixtures thereof. The above process, wherein said edible film or edible coating has pore sizes of about 100 nm to about 300 nm. The above process, wherein said micro-emulsion is composed of spherical particles with sizes ranging from about 100 to about 300 nm. The above process, wherein said edible film or edible coating has micro-channels of <600 nm. The above process, wherein high pressure homogenization is at >15,000 psi

An edible film or edible coating produced from the composition according to claim 1, wherein said film is produced by a process comprising (or consisting essentially of or consisting of) mixing at least one biopolymer, at least one active compound, at least one bio emulsifier, and at least one organic acid solution to form an emulsion, subjecting said emulsion to high pressure homogenization to form a micro-emulsion, and (1) pouring said micro-emulsion into a mold and allowing said micro-emulsion to harden into an edible film, and placing said edible film onto food, or (2) dipping said food into said micro-emulsion to form an edible coating on said food. The above edible film or edible coating, wherein high pressure homogenization is at >15,000 psi.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein). The invention illustratively disclosed herein suitably may be practiced in the absence of any element which is not specifically disclosed herein.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

We claim:

1. A composition suitable for making edible films or coatings, said composition comprising at least one biopolymer, at least one active compound, at least one bio emulsifier, and at least one organic acid solution.

2. The composition according to claim 1, wherein said at least one biopolymer is chitosan.

3. The composition according to claim 1, wherein said at least one active compound is selected from the group consisting of essential oils, antioxidants, flavorings, antimicrobials, and mixtures thereof.

4. The composition according to claim 1, wherein said bio emulsifier is bio-fiber gum.

5. The composition according to claim 1, wherein said at least one organic acid solution is selected from the group consisting of acetic acid, lactic acid, levulinic acid, and mixtures thereof.

6. A process for making an edible film or edible coating on food, said method comprising mixing at least one biopolymer, at least one active compound, at least one bio emulsifier, and at least one organic acid solution to form an emulsion, subjecting said emulsion to high pressure homogenization to form a micro-emulsion, and (1) pouring said micro-emulsion into a mold and allowing said micro-emulsion to harden into an edible film, and placing said edible film onto said food, or (2) dipping said food into said micro-emulsion to form an edible coating on said food.

7. The process according to claim 6, wherein said at least one biopolymer is chitosan.

8. The process according to claim 6, wherein said at least one active compound is selected from the group consisting of essential oils, antioxidants, flavorings, antimicrobials, and mixtures thereof.

9. The process according to claim 6, wherein said bio emulsifier is bio-fiber gum.

10. The process according to claim 6, wherein said at least one organic acid solution is selected from the group consisting of acetic acid, lactic acid, levulinic acid, and mixtures thereof.

11. The process according to claim 6, wherein said edible film or edible coating has pore sizes of about 100 nm to about 300 nm.

12. The process according to claim 6, wherein said micro-emulsion is composed of spherical particles with sizes ranging from about 100 to about 300 nm.

13. The process according to claim 6, wherein said edible film or edible coating has micro-channels of <600 nm.

14. The process according to claim 6, wherein high pressure homogenization is at >15,000 psi

15. An edible film or edible coating produced from the composition according to claim 1, wherein said film is produced by a process comprising mixing at least one biopolymer, at least one active compound, at least one bio emulsifier, and at least one organic acid solution to form an emulsion, subjecting said emulsion to high pressure homogenization to form a micro-emulsion, and (1) pouring said micro-emulsion into a mold and allowing said micro-emulsion to harden into an edible film, and placing said edible film onto food, or (2) dipping said food into said micro-emulsion to form an edible coating on said food.

16. The edible film or edible coating according to claim 15, wherein high pressure homogenization is at >15,000 psi.
